(19) United States
(12) Patent Application Publication
(10) Pub. No.: US 2019/0254253 A1
(43) Pub. Date: Aug. 22, 2019

(54) UNIVERSAL SILL MOUNTABLE DEVICE

(71) Applicant: K&H Manufacturing, LLC, Colorado Springs, IN (US)

(72) Inventor: James Donald Koskey, JR., Manitou Springs, IN (US)

(21) Appl. No.: 15/898,875

(22) Filed: Feb. 19, 2018

(51) Int. Cl. A01K 1/03; F16M 11/04; F16M 13/02; A47F 5/08; A01K 1/035

(52) U.S. Cl. CPC A01K 1/033; F16M 11/041; A01K 1/035; A47F 5/08; F16M 13/022

(57) ABSTRACT

The present disclosure relates in general to a pet habitat. The present disclosure describes a universal sill mountable device for mounting to a sill and a window, where the structure of windows and window systems vary. In particular, the present disclosure relates to a sill mountable device that includes selectably positionable leg for universal mounting, where the leg is affixed based at least in part on the width of the sill, so that the platform maintains a substantially horizontal posture when the device is mounted to a window.

### TECHNICAL FIELD

The present disclosure relates in general to a pet habitat, and particularly, to a universal window sill device that includes selectably positionable leg for universal mounting.

### BACKGROUND

Domestic cats are common pets in many households. Housing cats requires addressing cats' unique needs. For example, cats are known to prefer elevated locations as perches. Elevated perches offer cats comfort and safety so that they can identify threats, display status, keep out of reach (for example, from children, other animals, etc.), and exercise. These benefits lead to reduced stress and anxiety, improved mood, and overall healthier and better lives. In addition, households with multiple cats may also see less antagonistic behavior from cats, including confrontations and stand-offsss, by providing cats with separate perches.

Traditional perch systems include tree houses, and other cat-specific furniture. These traditional systems are often floor-standing, and take up valuable space in households. Some traditional systems may also require significant work to assemble and maintain. Moreover, providing a perch can be problematic because cats are known to be very selective, and a perch's initial location may not be favored by the cat. This would require the cat owner to move the perch to a location more desirable to the cat. If the perch is not easily movable or adaptable to the new location, it may be prohibitive of relocation and diminishes its value as a perch.

Other traditional systems include non-floor-standing systems. One type of such exemplary systems makes use of household windows and window ledges as mount locations. For example, a perch may be placed upon a window ledge, or mounted to a window pane. Added benefits of mounting a perch on or near windows are that cats can enjoy the sunlight coming in through the windows, or the views to the outside. However, window-mountable perches are problematic for a variety of reasons. Universally, the structure of windows and window systems vary. For example, window ledges may be of varying depths, which means that perches may need to be purpose-built for such ledge (and window) types. This is problematic because purpose-built perches are not easily reconfigurable, movable, or adaptable towards different mount locations. Moreover, given the fragile glass panes, window-based perch systems are limited in mount options (i.e. a nail cannot be used to mount the perch to the window).

Therefore, there is a need for a pet habitat which that is easily mountable, configurable, and movable. Accordingly, there exists a need for a universal sill mountable device.

### SUMMARY

A sill mountable device for mounting to a sill and a window is provided. In at least one embodiment of the present disclosure, the sill mountable device includes a platform comprising a rear edge and at least one mount mechanism, the at least one mount mechanism extending away from the rear edge along a width of the platform.

In at least one embodiment of the present disclosure, the sill mountable device includes a leg having a proximal end and a distal end, wherein the proximal end of the leg is affixed on the underside of the platform to the at least one mount mechanism, and selectably positionable on the at least one mount mechanism based at least in part on the width of the sill.

In at least one embodiment of the present disclosure, the sill mountable device includes at least one suction cup operably coupled to the rear edge of the platform, and wherein the platform maintains a substantially horizontal posture when the device is mounted to the window via the at least one suction cup, and wherein the distal end of the leg abuts the sill.

In at least one embodiment of the present disclosure, the leg comprises at least one hook member configured to be inserted into at least one of the plurality of mount apertures, and wherein the leg further comprises a first member and a curved member, wherein the first member and curved member join to form a support for the platform.

In at least one embodiment of the present disclosure, the sill mountable device further comprises at least one mount point extending substantially perpendicular to the rear edge of the platform, wherein the at least one suction cup is affixed to the at least one mount point.

### DESCRIPTION OF DRAWINGS

FIG. 1 is a top perspective view of a universal sill mountable device in accordance with an embodiment.

FIG. 2 is a partial top plan view of a universal sill mountable device in accordance with an embodiment.

FIG. 3 is a side elevational view of a leg of a universal sill mountable device in accordance with an embodiment.

FIG. 4A is a side elevational view of a universal sill mountable device mounted to a window in accordance with an embodiment.

FIG. 4B is a side elevational view of a universal sill mountable device mounted to a window and a sill in accordance with an embodiment.

FIG. 5 is a bottom perspective view of a universal sill mountable device in accordance with an embodiment.

FIG. 6 is a bottom perspective view of a universal sill mountable device in accordance with an embodiment.

FIG. 7 is partial bottom plan view of a universal sill mountable device in accordance with an embodiment.

FIG. 8 is a top perspective view of a of a universal sill mountable device in accordance with an embodiment.

FIG. 9 is a top plan view of a universal sill mountable device in accordance with an embodiment.

FIG. 10 is a top perspective view of a of a universal sill mountable device in accordance with an embodiment.

FIG. 11 is a top plan view of a universal sill mountable device in accordance with an embodiment.

FIG. 12 is a front perspective view of a universal sill mountable device in accordance with an embodiment.

FIG. 13 is partial bottom plan view of a universal sill mountable device in accordance with an embodiment.

FIG. 14 is a rear perspective view of a universal sill mountable device in accordance with an embodiment.

### DETAILED DESCRIPTION

Reference will now be made in detail to the preferred embodiments of the present disclosure, examples of which are illustrated in the accompanying drawings. Additional features and advantages of the disclosure will be set forth in the description that follows, and will be apparent from the description, or may be learned by practice of the disclosure. It is to be understood that both the foregoing general description and the following detailed description are exemplary and explanatory and are intended to provide further explanation of the disclosure as claimed.

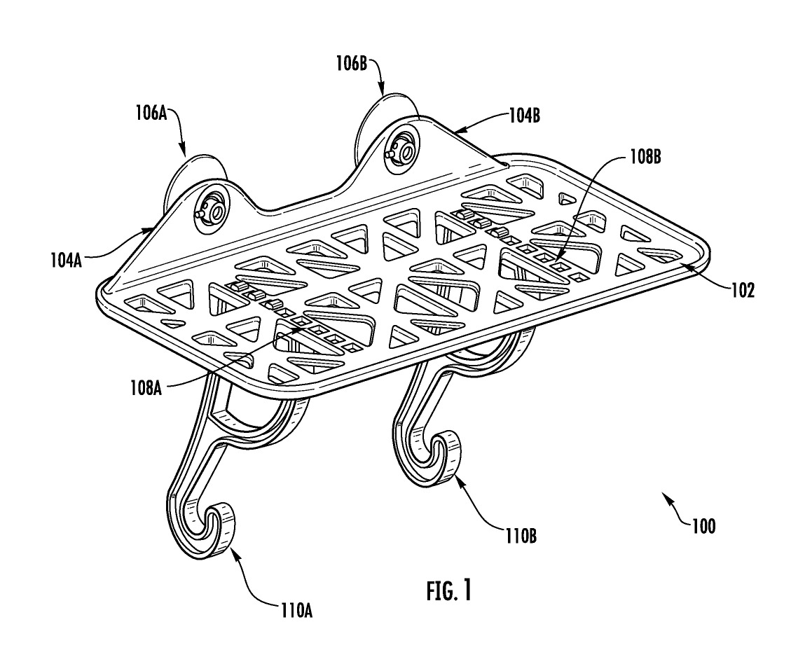

Referring now to FIG. 1, there is shown is a top perspective view of a universal sill mountable device 100 in accordance with at least one embodiment of the present disclosure. The sill mountable device includes a platform 102, mount points 104A and 104B, suctions cups 106A and 106B, leg mount sections 108A and 108B, and legs 110A and 110B.

In at least one embodiment of the present disclosure, the platform 102 includes a rectangular shaped shelf having a generally planar shelf portion, front and rear edges, and opposite side perimeter edges. It will be appreciated that the platform 102 may be of any shape, such as an oval, a square, or a circle, to name just a few non-limiting examples.

In at least one embodiment of the present disclosure, the platform 102 includes mount points 104A and 104B located at the rear edge of the platform 102, and integral with platform 102, as shown in FIG. 1. It will be appreciated that the mount points 104A and 104B may be a lip feature of the platform 102, wherein the lip feature protrudes upward from the rear edge, and is substantially perpendicular to the platform 102. For purposes of clarity, only a pair of mount points 104A and 104B are shown located on platform 102. However, it is within the scope of the present disclosure that the platform 102 may include any number of mount points located on the rear edge, and any of the other edges of the platform 102.

In at least one embodiment of the present disclosure, the mount points 104A and 104B are configured to receive suction cups 106A and 106B, respectively. It will be appreciated that the suction cups 106A and 106B are used to attach the sill mountable device 100 to another structure, such as, for example, a window (as shown and further disclosed below). It will be further appreciated that although only a pair of suction cups 106A and 106B are shown, it is within the scope of the present disclosure that the sill mountable device 100 may include any number of suction cups as there are mount points located on any of the edges of the platform 102.

In at least one embodiment of the present disclosure, the sill mountable device 100 may include any number of affixing mechanisms at the edges of the platform 102, to operably mount the sill mountable device 100 to another structure, such as, for example, tape, glue, clamps, magnet, or any other affixing mechanisms known to one having ordinary skill in the art.

In at least one embodiment of the present disclosure, the platform 102 includes leg mount sections 108A and 108B, in parallel to the side edges of the platform 102, and stretching about the length of the platform 102, as shown in FIG. 1. In at least one embodiment, the platform 102 may include fewer or more than two leg mount sections 108. In at least one embodiment of the present disclosure, the leg mount sections 108A and 108B may be located equidistant to each other and the side edges of the platform. In at least one embodiment of the present disclosure, the leg mount sections 108A and 108B may be located about the medial location of the platform 102. In at least one embodiment of the present disclosure, the leg mount sections 108A and 108B may extend along the full width of the platform 102. In at least one embodiment of the present disclosure, the leg mount sections 108A and 108B may extend only partially from the rear edge of the platform 102 to about the medial distance along the width of the platform 102.

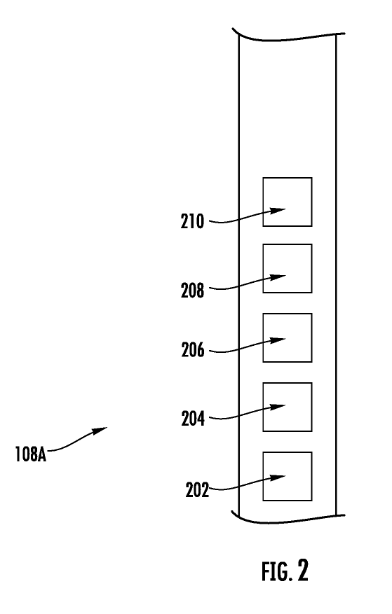

In at least one embodiment of the present disclosure, the each of the leg mount sections 108A and 108B includes at least one mount aperture. For example, referring now to FIG. 2, there is shown a leg mount section 108A, according to at least one embodiment of the present disclosure. In at least one embodiment of the present disclosure, the leg mount section 108A includes at least one mount aperture 202. It will be appreciated that the leg mount section 108A (or leg mount section 108B) may include any number of mount apertures (e.g. mount apertures 204-210) of a type well known to one having ordinary skill in the art, which collectively are operable to perform the functions delegated to mount apertures according to the present disclosure.

In at least one embodiment of the present disclosure, the mount aperture 202 and any plurality of mount apertures (e.g. mount apertures 204-210) are spaced evenly apart from each other, and along the length of the leg mount section 108A. It will be appreciated that the mount aperture 202 (and mount apertures 204-210) are configured to receive leg 110A, as further disclosed herein.

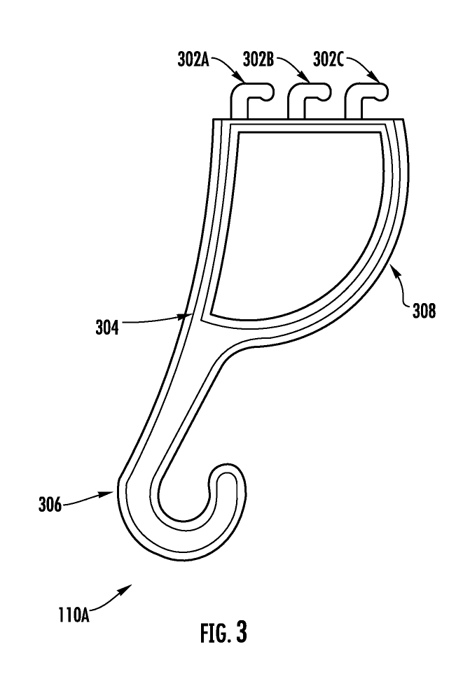

Referring now to FIG. 3, there is shown a side elevational view of a leg 110A of a universal sill mountable device in accordance with one embodiment of the present disclosure. The leg 110A includes a plurality of hook members 302A, 302B, and 302C, a first member 304, a distal end 306, and a curved member 308. In at least one embodiment of the present disclosure, the first member 304 and curved member 308 join to form a support for platform 102.

In at least one embodiment of the present disclosure, the hook members 302A, 302B and 302C are shaped in a miter and configured to be inserted into mount aperture 202 (or mount apertures 204-210). For example, the each of the hook members 302A, 302B, and 302C, may be positioned along leg mount section 108A and inserted into a mount aperture (e.g. mount apertures 202-210) such that the leg mount section 108A and the leg 110A engage and are attached to each other. It will be appreciated that in some embodiments the each of the hook members 302A, 302B, and 302C, are positioned equidistant from each other and spaced to be aligned with the insertion points of mount apertures such that the each of the hook members 302A, 302B, and 302C may be inserted into a corresponding mount aperture. Particularly, the mount apertures and hook members are shaped and dimensioned so as to cooperatively engage each other and operably affix leg 110A (or leg 110B) to platform 102.

It will be appreciated that although only three hook members 302A, 302B, and 302C are shown in FIG. 3, it is within the scope of the present disclosure that the leg 110A may include any number of hook members so as to ensure a secure engagement with the platform 102, via the mount apertures.

It will be further appreciated that the hook members and mount apertures may include any number of locking mechanisms commonly associated with the mounts utilized in many of the known perch systems, to operably attach the platform 102 and leg 110A (or leg 110B) to each other, as would be well known to one having ordinary skill in the art.

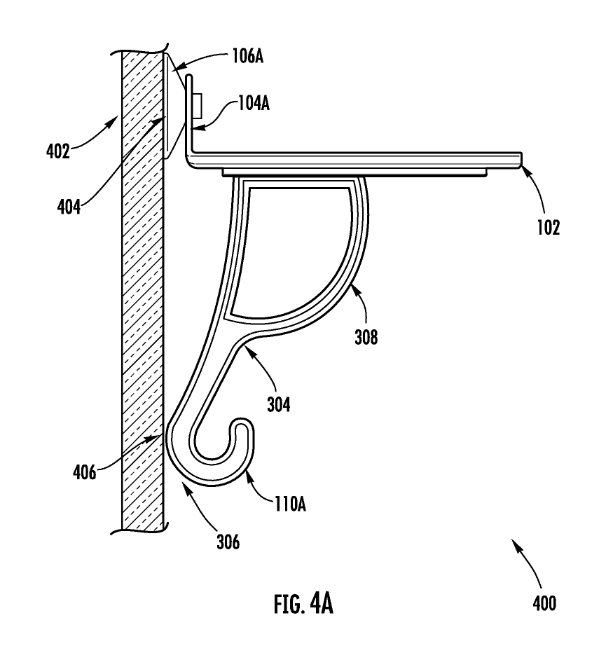

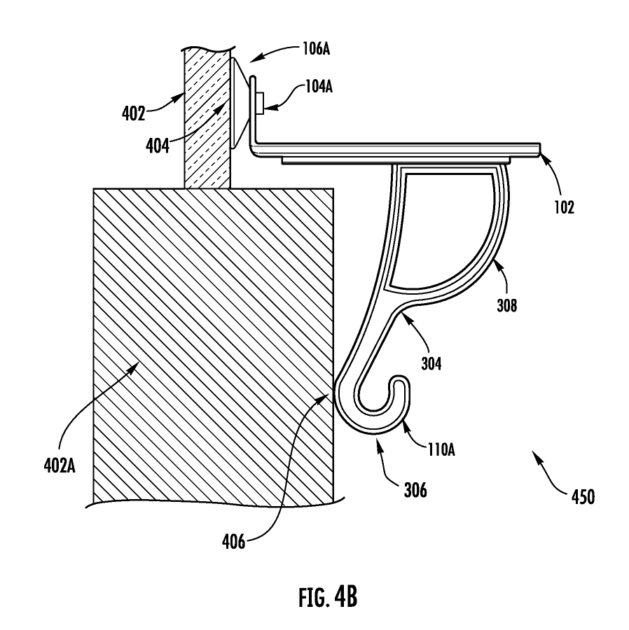

In at least one embodiment of the present disclosure, the leg 110A may be selectably positioned on the underside of the platform 102, and about the length of the leg mount section 108A, to accommodate differing sizes of a window sill. For example, referring to FIG. 4A, there is shown a side-view of a sill mountable device 100, according to at least one embodiment of the present disclosure, and generally indicated at 400. In FIG. 4A, there is shown a leg 110A that is selectably positioned such that the distal end 306 of the leg 110A is substantially co-linear with the suction cup 106A, and abuts a window 402 at about location 406. The suction cup 106A is affixed to window 402 at about location 404.

It will be appreciated that the sill mountable device 100 operates whereby any downward force caused by any object (e.g. a household cat) placed upon platform 102 is opposed by the inward force exerted by the leg 110A at the distal end 306, and against the window 402, and by the inward force exerted by suction cup 106A upon window 402, at about location 404.

In at least one embodiment of the present disclosure, the leg 110A may be selectably positioned about the length of the leg mount section 108A to accommodate for varying thickness of the window sill. For example, referring to FIG. 4B, there is shown a side-view of a sill mountable device 100, according to at least one embodiment of the present disclosure, and generally indicated at 450. In at least one embodiment of the present disclosure, the window 402 includes a sill 402A, the sill 402A having a width, that may be wider than the window 402, as shown in FIG. 4B. In at least one embodiment of the present disclosure, the leg 110A is selectably positioned about the length of the leg mount section 108A, based at least in part on the width of the sill 402A, and away from the rear edge of the platform 102, such that the distal end 306 abuts the wide-bodied sill 402A, while supporting the platform 102 at a substantially horizontal posture. It will be appreciated that the suction cup 106A and the distal end 306 are not co-linear, yet still operate in tandem to support the downward force of any object (e.g. a household cat) place upon platform 102.

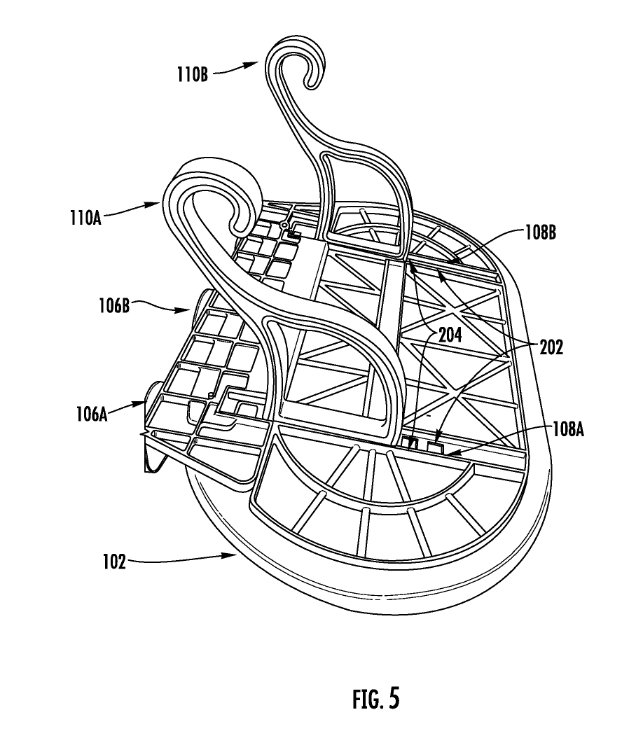

Referring now to FIG. 5, it is shown a bottom perspective view of a universal sill mountable device in accordance with an embodiment, generally indicated at 200. The sill mountable device 200 includes a platform 102, the platform 102 being of oval shape. The sill mountable device 200 further includes a plurality of mount apertures 202 and 204, leg 110A and 110B, and suction cups 106A and 106B, and leg mount sections 108A and 108B.

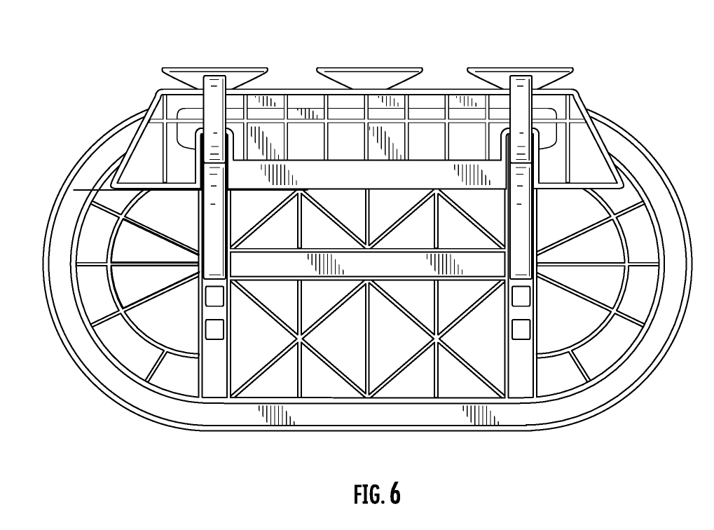

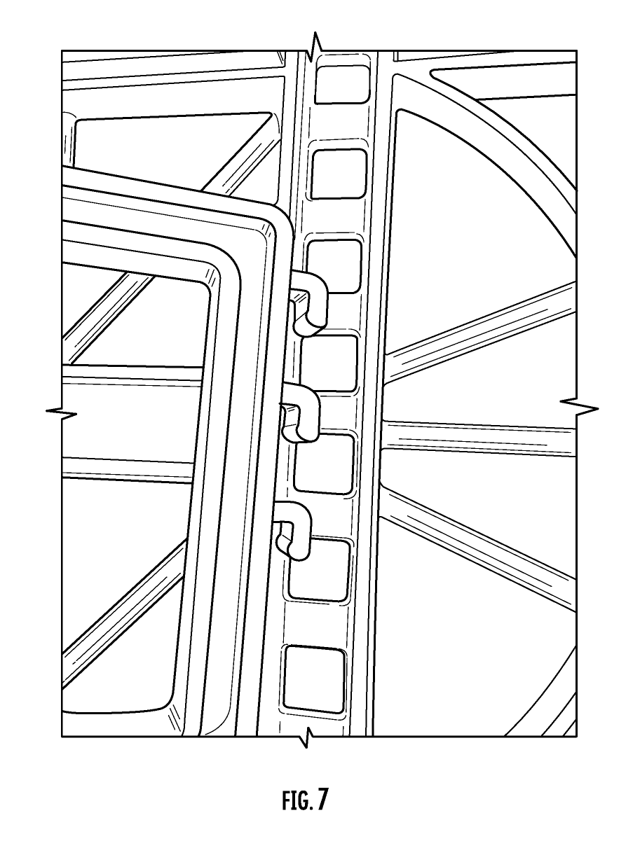

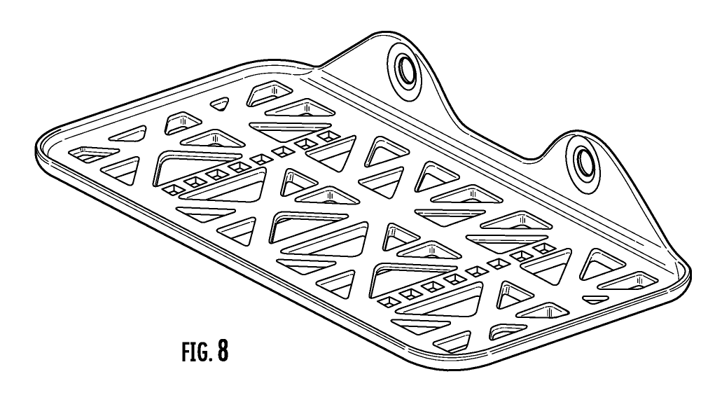

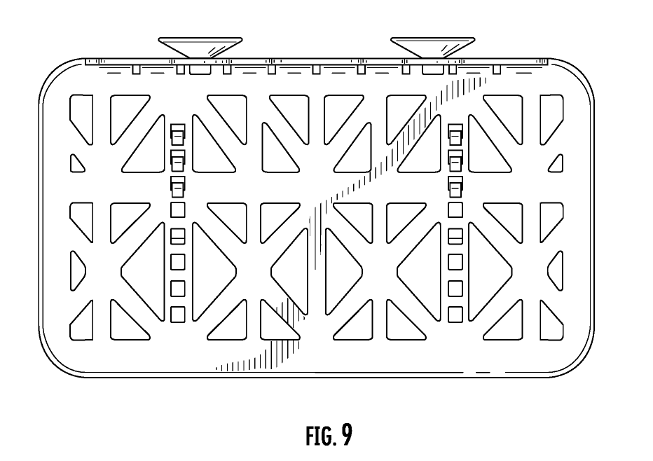

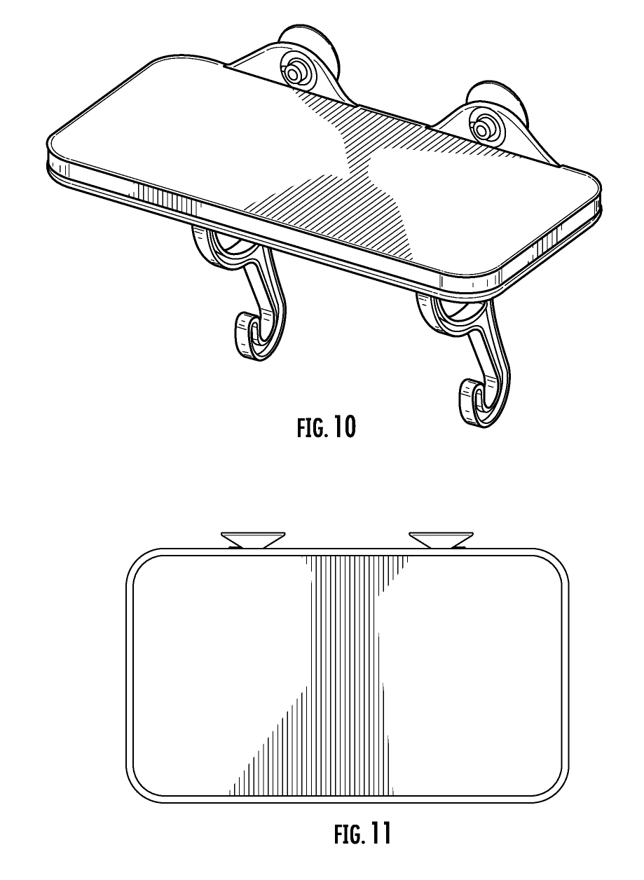

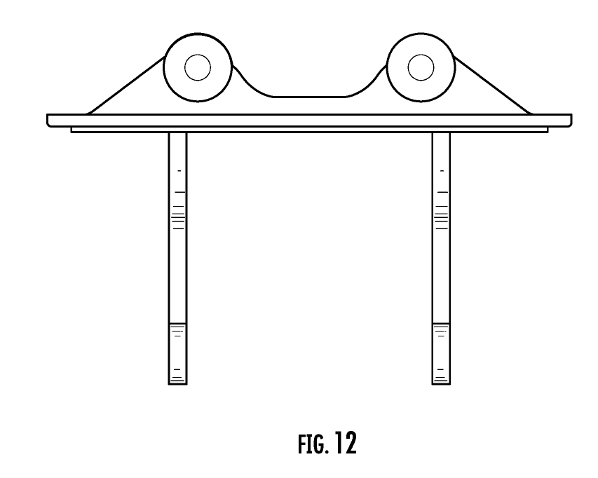

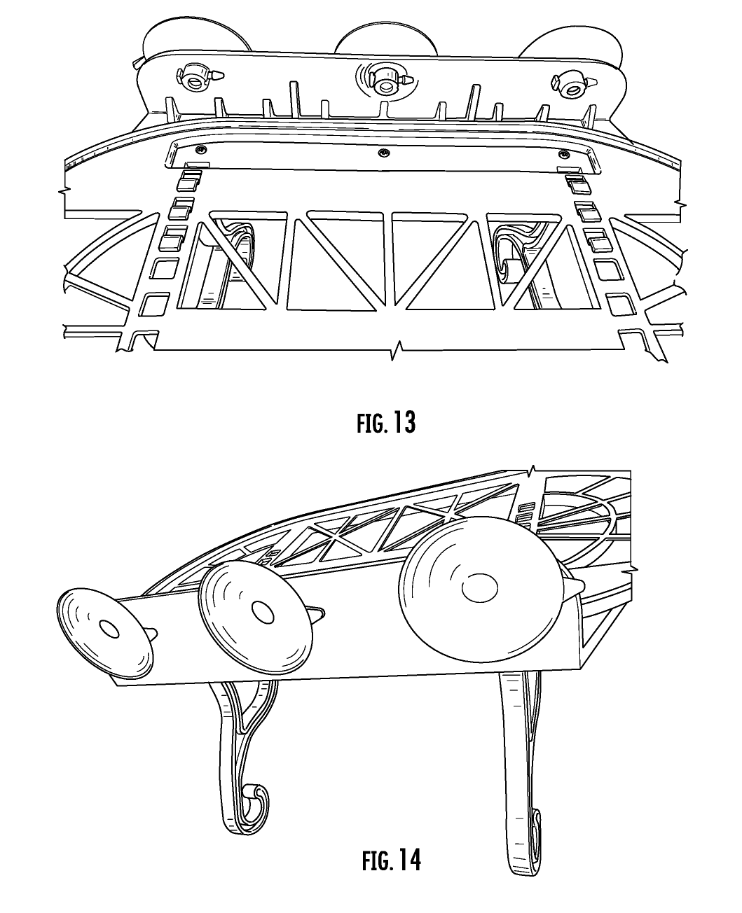

FIG. 6 is a bottom perspective view of a universal sill mountable device 100 in accordance with an embodiment. FIG. 7 is partial bottom plan view of a universal sill mountable device 100 in accordance with an embodiment. FIG. 8 is a top perspective view of a of a universal sill mountable device 100 in accordance with an embodiment. FIG. 9 is a top plan view of a universal sill mountable device 100 in accordance with an embodiment. FIG. 10 is a top perspective view of a of a universal sill mountable device 100 in accordance with an embodiment. FIG. 10 is a top plan view of a universal sill mountable device 100 in accordance with an embodiment. FIG. 11 is a top plan view of a universal sill mountable device 100 in accordance with an embodiment. FIG. 13 is partial bottom plan view of a universal sill mountable device 100 in accordance with an embodiment. FIG. 14 is a rear perspective view of a universal sill mountable device 100 in accordance with an embodiment.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

1. A sill mountable device for mounting to a sill and a window, the sill mountable device comprising:
a platform comprising a rear edge and at least one mount mechanism, the at least one mount mechanism extending away from the rear edge along a width of the platform;
a leg having a proximal end and a distal end;
wherein the proximal end of the leg is affixed on the underside of the platform to the at least one mount mechanism, and selectably positionable on the at least one mount mechanism based at least in part on the width of the sill; and
at least one suction cup operably coupled to the rear edge of the platform;
wherein the platform maintains a substantially horizontal posture when the device is mounted to the window via the at least one suction cup, and wherein the distal end of the leg abuts the sill.

2. The sill mountable device of claim 1, wherein the at least one mount mechanism comprises a plurality of mount apertures.

3. The sill mountable device of claim 2, wherein the leg comprises at least one hook member configured to be inserted into at least one of the plurality of mount apertures.

4. The sill mountable device of claim 1, further comprising at least one mount point extending substantially perpendicular to the rear edge of the platform, wherein the at least one suction cup is affixed to the at least one mount point.

5. The sill mountable device of claim 1 wherein the leg further comprises a first member and a curved member, wherein the first member and curved member join to form a support for the platform.

6. The sill mountable device of claim 1, wherein the at least one mount mechanism is located about the medial section of the platform.

7. The sill mountable device of claim 1, wherein the platform comprises a shape selected from an oval, square, rectangle, and circle.
